(19) United States
(12) Patent Application Publication
(10) Pub. No.: US 2009/0067843 A1
(43) Pub. Date: Mar. 12, 2009

(54) Optical Wavelength-Division-Multiplexed (WDM) Comb Generator Using a Single Laser

(76) Inventors: Winston I. WAY, Irvine, CA (US); Xing PAN, Sunnyvale, CA (US)

Correspondence Address: FISH & RICHARDSON, PC, P.O. BOX 1022, MINNEAPOLIS, MN, 55440-1022, US

(21) Appl. No.: 12/175,439

(22) Filed: Jul. 17, 2008

Related U.S. Application Data
(60) Provisional application No. 60/950,329, filed on Jul. 17, 2007.
(60) Provisional application No. 60/980,769, filed on Oct. 17, 2007.

(51) Int. Cl. H04J 14/02; H04J 14/00

(52) U.S. Cl. 398/79; 398/43

(57) ABSTRACT

Apparatus, systems and techniques that use a single laser to generate desired optical WDM comb frequencies.

### PRIORITY CLAIM AND RELATED PATENT APPLICATIONS

This patent application claims the benefits of U.S. Provisional Patent Application No. 60/950,329 entitled “Optical WDM Comb Generator Using A Single Laser” and filed Jul. 17, 2007, and U.S. Provisional Patent Application No. 60/980,769 entitled “Optical WDM Comb Generator Using A Single Laser” and filed Oct. 17, 2007. The entire disclosures of the above two patent applications are incorporated by reference as part of the specification of this patent application.

### BACKGROUND

This application relates to optical signal generation and optical modulation in optical communication and other applications.

Optical wavelength division multiplexing (WDM) can be used to use a single fiber to carry multiple optical channels at different WDM wavelengths. The frequency spacing between two adjacent WDM wavelengths can be reduced to increase the number of optical WDM channels carried by a fiber within a given spectral bandwidth. As the frequency spacing reduces, it is desirable to tightly control the frequency spacing so that the optical cross talk between two adjacent WDM channels is below a threshold to maintain proper operation and performance of optical communications. For example, an ultra dense WDM system can have a frequency spacing of 12.5 GHz with a baseband signal rate at 10 Gbps. The small frequency spacing and high data rate can lead to optical interference between two adjacent optical WDM channels due to nonlinear optical effects in fibers. When different lasers are used to produce different optical WDM channels, such lasers can be stabilized in frequency against frequency drifts and fluctuations in the lasers to reduce optical interference.

### SUMMARY

This application provides implementations for apparatus, systems and techniques that use a single laser to generate desired optical WDM comb frequencies.

In one aspect, an optical signal generator is provided to include a single laser that produces a continuous wave laser beam at a laser frequency; and an optical modulator that receives the laser beam from the single laser and modulates the laser beam in response to a plurality of electrical oscillation signals at different oscillation frequencies to produce a modulated laser beam that carries a plurality of pairs of optical sidebands corresponding to the oscillation frequencies. The optical sidebands in each pair comprise an upper sideband at an optical frequency higher than the laser frequency by a respective oscillation frequency of an electrical oscillation signal and a lower sideband at an optical frequency lower than the laser frequency by the respective oscillation frequency of the electrical oscillation signal. This signal generator includes an optical splitter that receives the modulated laser beam and separates the optical sidebands in the modulated laser beam into separate optical carriers along different optical paths, respectively; a plurality of optical baseband modulators respectively located in the optical paths, each optical baseband modulator operable to modulate a respective optical carrier to superimpose a baseband signal onto the respective optical carrier to produce an optical wavelength-division-multiplexed (WDM) channel signal; and an optical combiner that combines the optical WDM channel signals from the optical baseband modulators into a WDM signal.

In another aspect, an optical signal generator is provided to include a single laser that produces a continuous wave laser beam at a laser frequency; an optical modulator that receives the laser beam from the single laser and modulates the laser beam in response to a plurality of electrical oscillation signals at different oscillation frequencies to produce a modulated laser beam that carries a plurality of pairs of optical sidebands corresponding to the oscillation frequencies, wherein optical sidebands in each pair comprise an upper sideband at an optical frequency higher than the laser frequency by a respective oscillation frequency of an electrical oscillation signal and a lower sideband at an optical frequency lower than the laser frequency by the respective oscillation frequency of the electrical oscillation signal; an optical filter that receives the modulated laser beam from the optical modulator to suppress light at the laser frequency while transmitting the optical sidebands to produce an optical WDM beam carrying the pairs of optical sidebands; an optical splitter that receives the optical WDM beam and separates the optical sidebands into separate optical WDM carriers along different optical paths, respectively; a plurality of optical baseband modulators respectively located in the optical paths, each optical baseband modulator operable to modulate a respective optical WDM carrier to superimpose a baseband signal onto the respective optical WDM carrier to produce an optical WDM channel signal; and an optical combiner that combines the optical WDM channel signals from the optical baseband modulators into a WDM signal.

In another aspect, a method for producing an optical signal is provided to include optically modulating a continuous wave laser beam which is at a laser frequency at a modulation frequency to produce a modulated laser beam that carries a plurality of pairs of optical sidebands corresponding to different oscillation frequencies with a frequency spacing equal to a wavelength-division-multiplexed (WDM) channel spacing. The optical sidebands in each pair comprise an upper sideband at an optical frequency higher than the laser frequency by a respective oscillation frequency of an electrical oscillation signal and a lower sideband at an optical frequency lower than the laser frequency by the respective oscillation frequency of an electrical oscillation signal. This method includes optically filtering the modulated laser beam to suppress light at the laser frequency while transmitting the optical sidebands to produce an optical WDM beam carrying the pairs of optical sidebands; splitting the optical WDM beam into separate optical WDM carrier beams along different optical paths, respectively; optically modulating each separate optical WDM carrier beam to superimpose a baseband signal onto the respective optical WDM carrier beam to produce an optical WDM channel signal; and combining the optical WDM channel signals into a WDM signal.

In another aspect, a method for producing an optical signal is provided to include optically modulating a continuous wave laser beam which is at a laser frequency at a modulation frequency to produce a modulated laser beam that carries a plurality of optical sidebands corresponding to different oscillation frequencies; optically filtering the modulated laser beam to suppress light at the laser frequency while transmitting the optical sidebands to produce an optical WDM beam carrying the optical sidebands; splitting the optical WDM beam into separate optical WDM carrier beams along different optical paths, respectively; optically modulating each separate optical WDM carrier beam to superimpose a baseband signal onto the respective optical WDM carrier beam to produce an optical WDM channel signal; and combining the optical WDM channel signals into a WDM signal.

In yet another aspect, an optical signal generator is provided to include a laser that produces a continuous wave laser beam at a laser frequency; an optical modulator that receives the laser beam from the laser and modulates the laser beam in response to a plurality of electrical oscillation signals at different oscillation frequencies to produce a modulated laser beam that carries a plurality of optical sidebands corresponding to the oscillation frequencies at one side of the laser frequency while suppressing optical sidebands on the other side of the laser frequency and light at the laser frequency; and a plurality of adjustable electrical phase control units in signal paths of the electrical oscillation signals, respectively, to control phase values of the electrical oscillation signals. In one implementation, this optical signal generator may include a plurality of adjustable electrical power control units in signal paths of the electrical oscillation signals, respectively, to control power levels of the electrical oscillation signals. In another implementation, this optical signal generator may include an optical splitter that receives the modulated laser beam and separates the optical sidebands in the modulated laser beam into separate optical carriers along different optical paths, respectively; a plurality of optical baseband modulators respectively located in the optical paths, each optical baseband modulator operable to modulate a respective optical carrier to superimpose a baseband signal onto the respective optical carrier to produce an optical wavelength-division-multiplexed (WDM) channel signal; and an optical combiner that combines the optical WDM channel signals from the optical baseband modulators into a WDM signal.

These and other aspects are described in greater detail in the drawings, the description and the claims.

### BRIEF DESCRIPTION OF DRAWINGS

FIG. 1 shows an example of an optical WDM comb generator that uses a single-wavelength laser and a Mach-Zehnder interferometer (MZI) optical modulator to modulate the CW laser beam from the laser to produce a modulated laser beam with a desired WDM optical wavelength comb.

FIG. 2 illustrates an example of un-modulated WDM carriers without baseband signals and WDM channel signals carrying baseband signals via duobinary modulation.

FIG. 3 illustrates another example of an optical WDM comb generator that uses a single-wavelength laser and a Mach-Zehnder interferometer (MZI) optical modulator to modulate the CW laser beam from the laser to produce a modulated laser beam with a desired WDM optical wavelength comb, where the laser frequency of the laser is used as one of the WDM channel frequencies.

FIG. 4 shows an example of a polarization control mechanism to make polarization states of two adjacent optical WDM carriers to be orthogonal in an optical WDM comb generator.

FIGS. 5 and 6 show two examples of optical WDM comb generators based on optical single sideband modulation to provide individual phase control over generated comb carriers.

### DETAILED DESCRIPTION

When multiple lasers are used to generate desired optical WDM comb frequencies with an even frequency spacing for optical WDM channels, device aging, thermal fluctuations and other factors can cause the laser frequencies of the lasers to change and such changes can vary from laser to laser. Laser stabilization control may be implemented at each laser to stabilize the laser frequency but it remains difficult to stabilize different lasers with respect to one another. It is possible to use a common wavelength locker such as an etalon with a repetitive filter spacing equal to the ultra-dense WDM channel spacing. See examples in U.S. Pat. Nos. 7,068,949 and 6,369,923. This approach can be difficult to generate arbitrarily-spaced or non-repetitive optical frequency combs.

This application describes implementations of apparatus, systems and techniques that use a single laser to generate desired optical WDM comb frequencies to provide tightly controlled frequency spacing between WDM channels. The described techniques can be used to generate comb frequencies with an arbitrary, unequal, or non-repetitive spacing. Aging and fluctuations at the single laser, although causing all optical WDM comb frequencies to change, cause all WDM channels to fluctuate in the same manner. Therefore, the frequency spacing between two adjacent WDM channels does not change significantly. Such designs that use a single laser to produce the WDM channel signals can be simple to implement at a relatively low cost and yet capable of achieving desired channel spacing control in closely spaced WDM channels at high data rates. The implementations described in the following examples use a two-stage design where an optical modulation stage is provided to modulate a continuous wave (CW) signal to produce desired optical sidebands at the optical WDM wavelengths with a desired spacing between two adjacent sidebands and a subsequent baseband modulation stage is used to modulate different optical beams at the different optical sidebands, respectively, to produce different optical WDM channel signals. Such optical WDM channel signals are combined to produce the final optical WDM signal for transmission in a fiber link or fiber network.

In one implementation, a method for producing an optical WDM signal is described to include optically modulating a continuous wave laser beam at a laser frequency to produce a modulated laser beam that carries a plurality of pairs of optical sidebands corresponding to different oscillation frequencies with a frequency spacing equal to any desired WDM channel spacing. The optical sidebands in each pair includes an upper sideband at an optical frequency higher than the laser frequency by a respective oscillation frequency of an electrical oscillation signal and a lower sideband at an optical frequency lower than the laser frequency by the respective oscillation frequency of an electrical oscillation signal. This method includes optically filtering the modulated laser beam to suppress light at the laser frequency while transmitting the optical sidebands to produce an optical WDM beam carrying the pairs of optical sidebands; splitting the optical WDM beam into separate optical WDM carrier beams along different optical paths, respectively; optically modulating each separate optical WDM carrier beam to superimpose a baseband signal onto the respective optical WDM carrier beam to produce an optical WDM channel signal; and combining the optical WDM channel signals into a WDM signal.

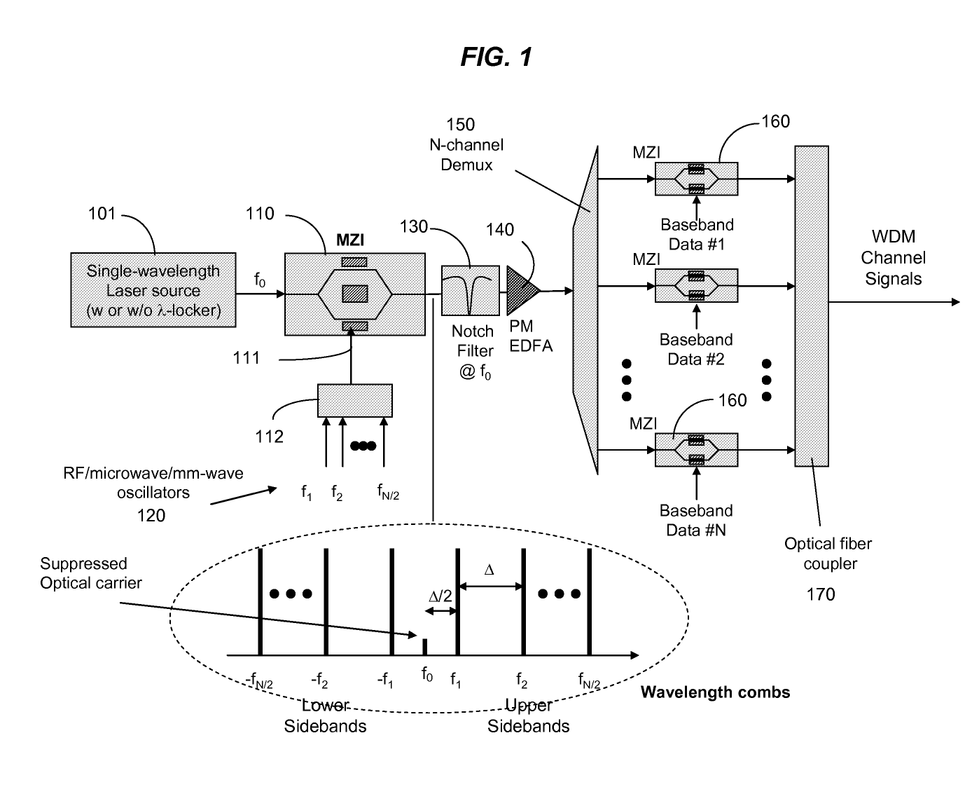

FIGS. 1-4 illustrate examples of optical signal generators and their operations. In these examples, an optical signal generator includes a single laser that produces a continuous wave laser beam at a laser frequency and an optical modulator that receives the laser beam from the single laser and modulates the laser beam in response to a plurality of electrical oscillation signals at different oscillation frequencies to produce a modulated laser beam that carries pairs of optical sidebands corresponding to the oscillation frequencies. The optical sidebands in each pair include an upper sideband at an optical frequency higher than the laser frequency by a respective oscillation frequency of an electrical oscillation signal and a lower sideband at an optical frequency lower than the laser frequency by the respective oscillation frequency of the electrical oscillation signal. An optical filter, such as an optical notch filter, may be used to receive the modulated laser beam from the optical modulator to suppress light at the laser frequency while transmitting the optical sidebands to produce an optical WDM beam carrying the pairs of optical sidebands. An optical splitter is used to receive the optical WDM beam and separate the optical sidebands into separate optical WDM carriers along different optical paths, respectively. Optical baseband modulators are respectively located in the optical paths. Each optical baseband modulator is operable to modulate a respective optical WDM carrier to superimpose a baseband signal onto the respective optical WDM carrier to produce an optical WDM channel signal. The generators in these examples also use an optical combiner that combines the optical WDM channel signals from the optical baseband modulators into a WDM signal.

Referring to FIG. 1, a single-wavelength laser 101 with or without a wavelength locker can be used to produce the CW laser beam. A Mach-Zehnder interferometer (MZI) optical modulator 110 is used to modulate the CW laser beam to produce a modulated laser beam with a desired WDM optical wavelength comb. Multiple electrical signal oscillators 120, such as RF, microwave or mm-wave signal oscillators, can be used to produce RF, microwave or mm-wave oscillation signals at N/2 different frequencies (e.g., f1, f2, . . . , and f_{N/2}) to produce N WDM channels. The frequency spacing Δ between two oscillation signals at adjacent frequencies is set to be the desired WDM frequency spacing for the WDM channels. An electrical signal combiner 112 is used to combine the different electrical oscillation signals into a modulation control signal 111 that is applied to the optical modulator 110.

As an example, the optical modulator 110 can be configured to perform optical double sideband (ODSB) modulation to produce two optical sidebands under optical modulation in response to each electrical oscillation signal contained in the signal 111. Each electrical oscillation signal does not carry a baseband signal and is used to produce optical carriers for the optical WDM channels. The insert in FIG. 1 illustrates the upper sideband and the symmetric lower sideband for each of oscillation signals at f1, f2, . . . , and f_{N/2} in the modulation control signal 111. One example of ODSB using MZI modulators is described in U.S. Pat. No. 7,003,231 which is incorporated by reference as part of the specification of this application. The lowest oscillation frequency f1 is set at a frequency equal to one half of the WDM channel spacing Δ. The remaining oscillators should have frequencies fn=f1+n Δ (n=2, 3, . . . , N/2). This arrangement places the laser frequency to be different from any of the optical WDM channel frequencies. The MZI optical modulator 110 can be electrically biased at the minimum power point of its transfer function to suppress optical carrier light at the laser frequency f0 in the output. A notch filter 130 is provided to further suppress the residual optical carrier at f0 due to the finite extinction ratio of the MZI at its minimum bias level. The single-wavelength laser 101 can be tuned to lase at the notch center frequency f0 of the optical notch filter 130 and can be locked to f0 so that light at f0 is blocked by the optical notch filter 130. An optical amplifier 140, such as a polarization-maintaining (PM) doped fiber amplifier (e.g., Er-doped), can be used to amplify the N WDM carrier signals. An N-channel WDM demultiplexer 150 is implemented as the optical splitter to separate the N WDM carrier signals into separate optical beams along separate optical paths, respectively.

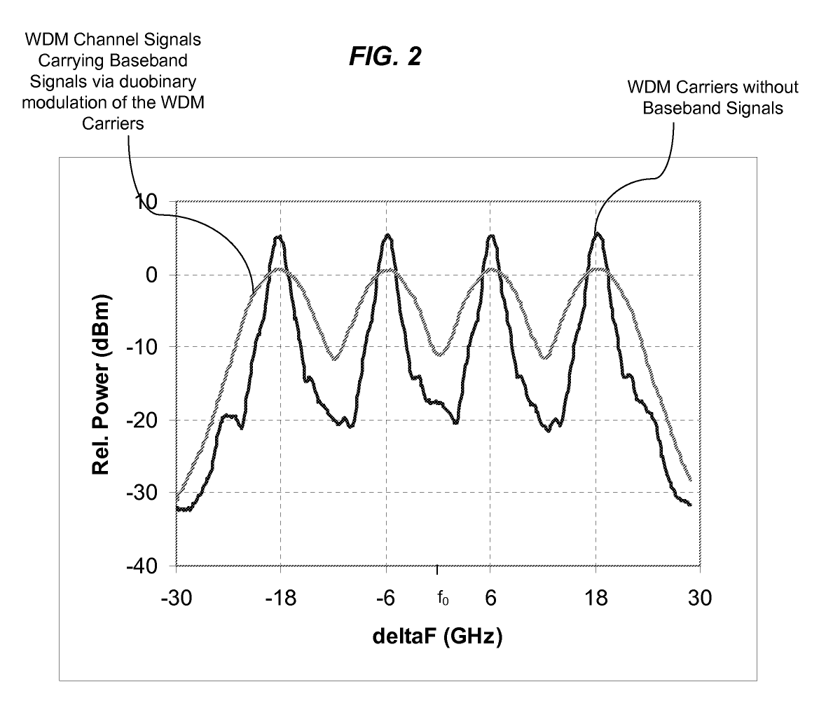

Multiple optical baseband modulators 160, such as MZI modulators, are placed in the optical paths of the separated WDM carriers, respectively, to modulate the carriers to carry N baseband signals which may carry different baseband data signals. The modulated carriers are optical WDM channel signals. Each MZI modulator may be operated to perform duobinary modulation on a respective WDM carrier beam. FIG. 2 illustrates an example of un-modulated WDM carriers without baseband signals and WDM channel signals carrying baseband signals via duobinary modulation. Other baseband modulation techniques may also be used to perform the optical modulation. Examples of signal modulation techniques include On-off-keying (OOK), differential phase-shifted-keying (DPSK), M-ary phase-shifted-keying (MPSK) with M being equal to or greater than 2, quadrature-amplitude-modulation (QAM), and orthogonal-frequency-division-multiplexing (OFDM). An optical fiber coupler 170 can be implemented as an optical combiner to combine the modulated WDM channel signals into the combined WDM signal for transmission over a fiber link. Notably, electrical modulation control signals at the different oscillation frequencies can be applied to the optical Mach-Zehnder modulator which performs the optical modulation to generate the optical sidebands for the optical comb and a signal phase in each of the electrical modulation control signals can be controlled to reduce nonlinear distortions of the optical Mach-Zehnder modulator and other optical fiber nonlinearities during transmission.

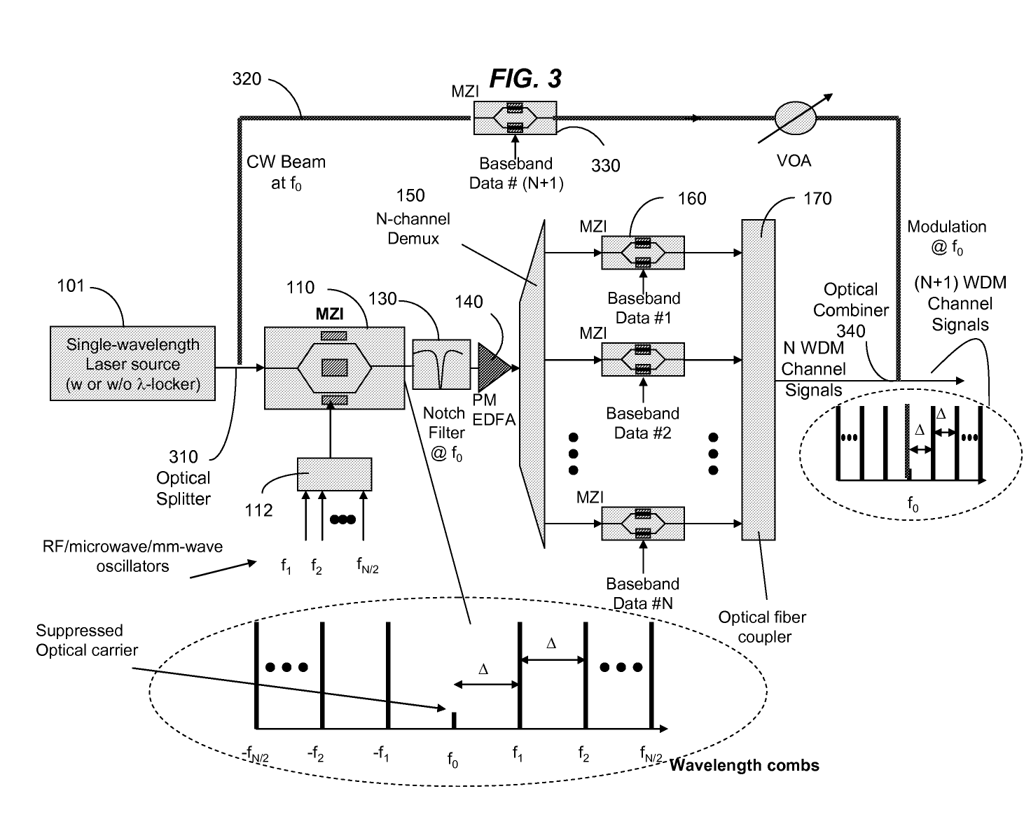

FIG. 3 illustrates another example of an optical WDM comb generator where the laser frequency of the laser 101 is used as one of the WDM channel frequencies. This is different from the design in FIG. 1 where the laser frequency of the laser 101 is not used as a WDM channel frequency. The lowest oscillation frequency fl is set at a frequency equal to the WDM channel spacing Δ. The remaining oscillators should have frequencies fn=f1 +n Δ (n=2, 3, . . . , N/2). In FIG. 3, an additional optical splitter 310 is coupled between the single laser 101 and the optical modulator 110 to split a fraction of the laser beam into a bypass laser beam 320 at the laser frequency to bypass the modulator 110 and the subsequent baseband modulators. The beam 320 is directly modulated by a baseband optical modulator 330 to carry a baseband signal at the carrier at the laser frequency f0. An additional beam comber 340 is coupled to the output path of the N WDM channel signals produced by the beam combiner 170 to produce (N+1) WDM channel signals. A variable optical attenuator may be used to control the amplitude of the signal 320 so that the amplitudes of the N+1 channels are approximately the same. The output WDM signal of this design carries baseband signals at both the laser frequency and the optical sidebands.

The polarization states of the different WDM channel signals in the generators in FIGS. 1 and 3 can be controlled to make the polarization states of two adjacent channels in frequency to be orthogonal to each other so that the optical cross talk between adjacent channels can be reduced.

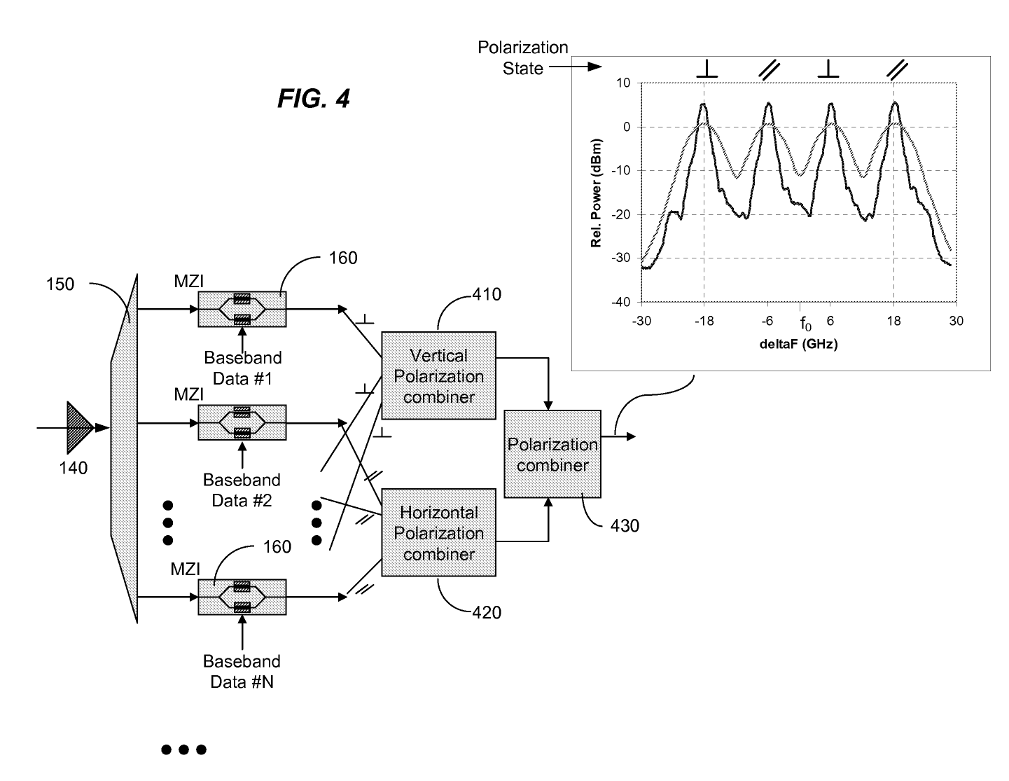

FIG. 4 illustrates one example of a polarization control mechanism to make polarization states of two adjacent optical WDM carriers to be orthogonal in an optical WDM comb generator. The polarization states of the modulated signals from the baseband modulators 160 are controlled so that the optical WDM channel signals output by the baseband modulators 160 are in either a first polarization or a second polarization which is orthogonal to the first polarization and two adjacent optical WDM channel signals are in first and second polarizations, respectively. Polarization controllers or rotators may be coupled downstream from the baseband modulators 160 in the separate optical paths to achieve this polarization configuration. This design effectually doubles the frequency separation of two adjacent WDM channels that can interfere with each other in comparison with the same design without the polarization shown in FIG. 4.

In addition to the ODSB modulation, optical combs can also be generated by using an optical single sideband (OSSB) modulation technique which preserves a sideband of an RF modulation on one side of the laser frequency f0 while suppressing the sideband on the other side. An RF modulation tone is split into two RF modulation signals which are applied to both optical branches of the MZI modulator with a 90-degree phase shift relative to each other. Examples of OSSB are described in U.S. Pat. No. 7,003,231. Single-sideband modulation allows arbitrarily spaced combs on either side of the laser frequency f0 to be generated and provides flexibility that is difficult to achieve with ODSB.

In both ODSB and OSSB modulations for the present optical WDM comb generators, the RF/microwave oscillator is used to convert the energy in the RF/microwave carrier tone into either a single optical sideband in the OSSB modulation or two optical sidebands in the ODSB modulation while minimizing signal power in other signal components of the modulation. Therefore, such modulation is efficient and renders the optical comb power reasonably strong. In operation, the RF/microwave oscillator drive power to the MZI modulator or another different optical modulator so that the generated combs have negligible harmonic or intermodulation components.

In an optical WDM comb generator based on a single laser with either ODSB modulation or OSSB modulation, phase control can be applied to each RF, microwave, or millimeter wave modulating tone to reduce the adjacent coherent crosstalk between the generated comb carriers. The nonlinear distortions in the Mach-Zehnder modulator and other optical fiber nonlinear mechanisms can also be minimized. The phase control based on ODSB can be implemented by providing adjustable RF phase control units in the signal paths of the multiple RF carriers (f1, f2, . . . , fN) at locations upstream from the RF signal combiner 112. Each RF phase control unit can independently control the phase for a respective RF carrier and its mirror image on the other side of the optical carrier f0. Hence, under ODSB, the phase of two mirror imaged carriers on the opposite sides of the optical carrier f0 is controlled at the same time and cannot be independently controlled.

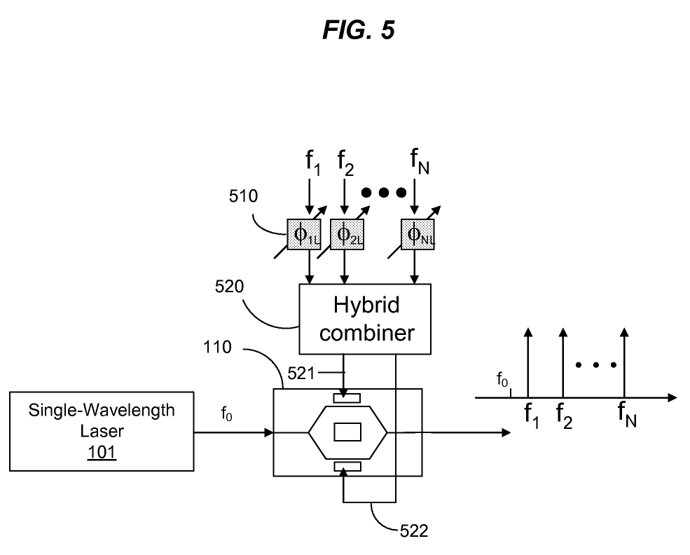

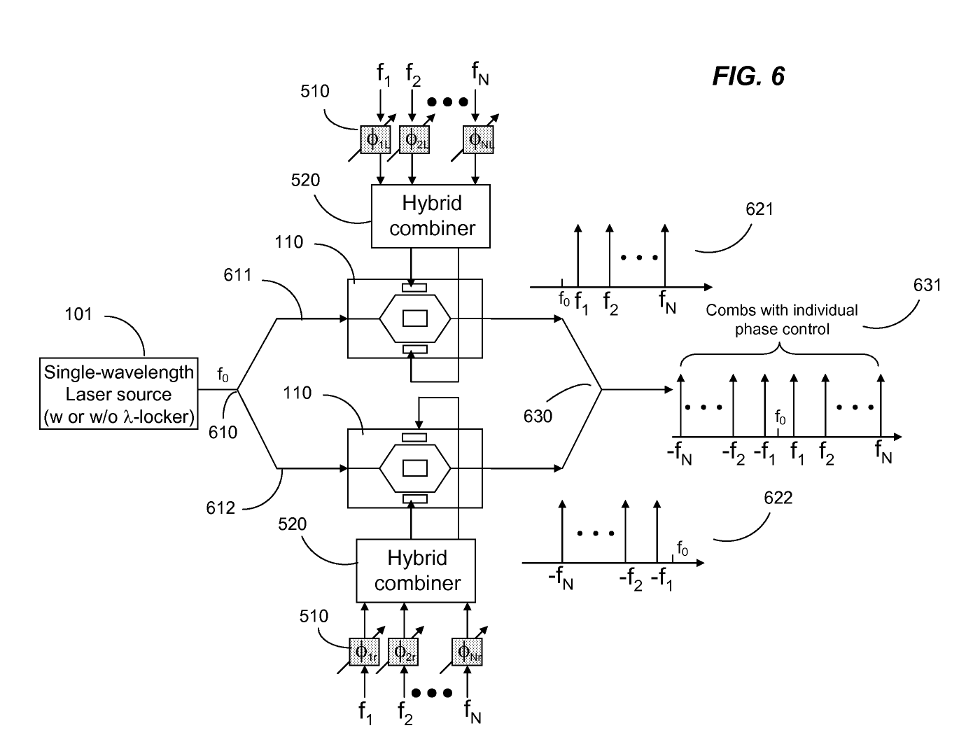

Phase control of individual carriers can be implemented based in OSSB modulation where the phase of each of the multiple comb carriers is controlled. FIGS. 5 and 6 show two examples of optical WDM comb generators based on OSSB modulation to provide such phase control.

In FIG. 5, the two optical branches of the MZI modulator 110 are applied with, respectively, two RF control signals 521 and 522 each carrying multiple RF carriers f1, f2, . . . , fN. Under OSSB, the two RF controls signals are phase shifted relative to each other by 90 degrees and the two optical branches are DC biased relative to each other by 90 degrees. An RF signal combiner 520 is provided to combine the multiple RF carriers f1, f2, . . . , fN and to produce the two phase-shifted RF control signals 521 and 522. The optical interference between the two modulated optical carrier signals from the two optical branches suppressed the optical carrier at f0 and sidebands on one side of the optical carrier. In the example shown, the upper sidebands are preserved as the output optical comb carriers. The spacing of the optical comb carriers are determined by the RF carrier frequencies f1, f2, . . . , fN and the spacing between different adjacent carriers can be different depending on the values of the RF carrier frequencies f1, f2, . . . , fN. This provide flexibility in generating desired comb frequency spacings.

Notably, adjustable RF phase control units 510 are provided in the signal paths of the multiple RF carriers f1, f2, . . . , fN upstream from the RF signal combiner 520. Each RF phase control unit 510 can independently control the phase for a respective RF carrier. Consequently, the phase values of the output comb carriers at f1, f2, . . . , fN can be individually controlled at desired values for specification applications.

One application of such a comb generator for producing phase-controlled comb carriers, for example, is a transmitter for communications based on orthogonal frequency division multiplexing (OFDM) where two adjacent carriers are orthogonal to each other in phase. In various OFDM systems, the phase values of OFDM carriers are generated and controlled digitally. The device in FIG. 5 can be used to generate OFDM carriers in the analog domain. The adjustable RF phase control units 510 are operated to control individual phases of the multiple RF carriers f1, f2, . . . , fN to render orthogonal phases between to adjacent carriers in the output carriers in the optical domain at the output of the MZI modulator 110.

FIG. 6 shows another example of a comb generator based on OSSB modulation to provide phase control. This comb generator provides an optical splitter 610 to split the CW laser beam at f0 from the laser 101 into two optical paths 611 and 612. Each of the two optical paths 611 and 612 includes a comb generator shown in FIG. 5 to generate comb carriers on one side of the optical carrier f0. The two comb generators in the two optical paths 611 and 612 are controlled so that the comb carriers 621 in the upper optical path 611 and the comb carriers 622 in the lower optical path 612 are on the opposite sides of the optical carrier f0. An optical combiner 630 is provided to combine the two optical paths 611 and 612 and to produce an optical output 631 with comb carriers on both sides of the optical carrier f0. The adjustable RF phase control units 510 in the two comb generators in the two optical paths 611 and 612 are operated to control individual phases of the multiple RF carriers f1, f2, . . . , fN and −f1, −f2, . . . , −fN to render orthogonal phases between to adjacent carriers in the output 631. This output 631 can be used in OFDM communications. One of advantages of using two parallel single-sideband modulators in FIG. 6 is that twice as many optical combs can be generated using the same RF oscillators in comparison with the device in FIG. 5.

In addition to the phase control, the power levels of individual generated comb carriers can be controlled. This control of the comb power can be implemented in the RF domain by adjustable RF amplifiers or attenuators or in the optical domain by adjustable optical amplifiers or attenuators. A combination of both optical power control and RF power control can also be implemented.

The RF domain power control can provide adjustable RF amplifiers or attenuators in the signal paths of the multiple RF carriers at f1, f2, . . . , fN. In FIGS. 1 and 3, such adjustable RF amplifiers or attenuators can be connected in the signal paths up stream from the signal combiner 112. In FIGS. 5 and 6, such adjustable RF amplifiers or attenuators can be connected in the signal paths up stream from the signal combiner 520.

The optical domain power control can provide adjustable RF amplifiers or attenuators in the signal paths of the separated optical paths after the optical WDM demultiplexer 150 in FIGS. 1 and 3. In FIGS. 5 and 6, a similar optical WDM demultiplexer can be provided at the output to separate the different comb carriers in the optical domain into separate optical paths in which baseband optical modulators 160 can be used to modulate comb carriers to carry data. Accordingly, adjustable optical amplifiers or attenuators can be respectively placed in the separated optical paths, either before or after the baseband optical modulators 160, to provide individual power control of the comb carriers.

The above optical signal generators can be used in various optical WDM communication systems, devices and applications.

While this specification contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. Variations and enhancements of the described implementations and other implementations may be made based on what is described and illustrated.

What is claimed is:

1. An optical signal generator, comprising:
a single laser that produces a continuous wave laser beam at a laser frequency;
an optical modulator that receives the laser beam from the single laser and modulates the laser beam in response to a plurality of electrical oscillation signals at different oscillation frequencies to produce a modulated laser beam that carries a plurality of pairs of optical sidebands corresponding to the oscillation frequencies, wherein optical sidebands in each pair comprise an upper sideband at an optical frequency higher than the laser frequency by a respective oscillation frequency of an electrical oscillation signal and a lower sideband at an optical frequency lower than the laser frequency by the respective oscillation frequency of the electrical oscillation signal;
an optical splitter that receives themodulated laser beam and separates the optical sidebands in the modulated laser beam into separate optical carriers along different optical paths, respectively;
a plurality of optical baseband modulators respectively located in the optical paths, each optical baseband modulator operable to modulate a respective optical carrier to superimpose a baseband signal onto the respective optical carrier to produce an optical wavelength-division-multiplexed (WDM) channel signal; and
an optical combiner that combines the optical WDM channel signals from the optical baseband modulators into a WDM signal.

2. The optical signal generator as in claim 1, wherein the optical modulator is a Mach-Zehnder optical modulator that operates in an optical double sideband modulation configuration and is biased at the minimum optical power of an optical power transfer function of the Mach-Zehnder optical modulator to produce.

3. The optical signal generator as in claim 2, wherein the Mach-Zehnder optical modulator is electrically biased to suppress light at the laser frequency in the modulated laser beam.

4. The optical signal generator as in claim 1, wherein the single laser is a tunable laser.

5. The optical signal generator as in claim 1, wherein the single laser is a laser that is locked at the laser frequency.

6. The optical signal generator as in claim 1, comprising:
an optical filter that receives the modulated laser beam from the optical modulator to suppress light at the laser frequency while transmitting the optical sidebands to produce an optical WDM beam carrying the pairs of optical sidebands, and the optical filter has a center frequency at the laser frequency of the laser to remove light at the laser frequency.

7. The optical signal generator as in claim 1, wherein the single laser is a single frequency laser.

8. The optical signal generator as in claim 1, wherein each optical baseband modulator is configured to produce signal modulation in a duobinary format.

9. The optical signal generator as in claim 1, wherein each optical baseband modulator is configured to produce signal modulation in an On-off-keying (OOK) format.

10. The optical signal generator as in claim 1, wherein each optical baseband modulator is configured to produce signal modulation in a differential phase-shifted-keying (DPSK) format.

11. The optical signal generator as in claim 1, wherein each optical baseband modulator is configured to produce signal modulation in a M-ary-phase-shifted-keying (MPSK) format (M≧2).

12. The optical signal generator as in claim 1, wherein each optical baseband modulator is configured to produce signal modulation in a quadrature-amplitude-modulation (QAM) format.

13. The optical signal generator as in claim 1, wherein each optical baseband modulator is configured to produce signal modulation in an orthogonal-frequency-division-multiplexing (OFDM)format.

14. The optical signal generator as in claim 1, wherein the single laser is an external cavity diode laser.

15. The optical signal generator as in claim 1, wherein
the optical WDM channel signals are in either a first polarization or a second polarization, the first and second polarizations being orthogonal to each other;
two adjacent optical WDM channel signals are in first and second polarizations, respectively; and
the optical combiner comprises:
a first optical combiner to receive optical WDM channel signals in the first polarization and to combine the received optical WDM channel signals in the first polarization to produce a first combined WDM beam;
a second optical combiner to receive optical WDM channel signals in the second polarization and to combine the received optical WDM channel signals in the second polarization to produce a second combined WDM beam; and
a third optical combiner that receives the first and second combined WDM beams to produce the WDM signal.

16. The optical signal generator as in claim 1, wherein two neighboring optical WDM channel signals have orthogonal polarizations.

17. The optical signal generator as in claim 1, wherein:
the optical WDM channel signals are in either a first polarization or a second polarization, the first and second polarizations being orthogonal to each other;
two adjacent optical WDM channel signals are in first and second polarizations, respectively; and
the optical combiner comprises:
a first optical combiner to receive optical WDM channel signals in the first polarization and to combine the received optical WDM channel signals in the first polarization to produce a first combined WDM beam;
a second optical combiner to receive optical WDM channel signals in the second polarization and to combine the received optical WDM channel signals in the second polarization to produce a second combined WDM beam; and
a third optical combiner that receives the first and second combined WDM beams to produce the WDM signal.

18. The optical signal generator as in claim 17, comprising:
a first optical splitter coupled between the single laser and the optical modulator to split a fraction of the laser beam into a first laser beam at the laser frequency;
a first optical baseband modulator that receives the first laser beam and modulates the first laser beam to superimpose a baseband signal onto the first laser beam to produce a first optical WDM channel signal at the laser frequency; and
a first optical combiner located in an optical path of the WDM signal output by the third optical combiner to combine the first optical WDM channel signal at the laser frequency and the WDM signal to produce an output WDM signal that carries baseband signals at the laser frequency and the optical sidebands.

19. The optical signal generator as in claim 1, comprising:
a first optical splitter coupled between the single laser and the optical modulator to split a fraction of the laser beam into a first laser beam at the laser frequency;
a first optical baseband modulator that receives the first laser beam and modulates the first laser beam to superimpose a baseband signal onto the first laser beam to produce a first optical WDM channel signal at the laser frequency; and
a first optical combiner located in an optical path of the WDM signal output by the optical combiner to combine the first optical WDM channel signal at the laser frequency and the WDM signal to produce an output WDM signal that carries baseband signals at the laser frequency and the optical sidebands.

20. The optical signal generator as in claim 1, comprising:
a plurality of adjustable electrical phase control units in signal paths of the electrical oscillation signals, respectively, to control phase values of the electrical oscillation signals.

21. The optical signal generator as in claim 1, comprising:
a plurality of adjustable electrical power control units in signal paths of the electrical oscillation signals, respectively, to control power levels of the electrical oscillation signals.

22. The optical signal generator as in claim 1, comprising:
a plurality of adjustable optical power control units in the different optical paths down stream from the optical splitter, respectively, to control power levels in the optical paths.

23. A method for producing an optical signal, comprising:
optically modulating a continuous wave laser beam which is at a laser frequency at a modulation frequency to produce a modulated laser beam that carries a plurality of pairs of optical sidebands corresponding to different oscillation frequencies with a frequency spacing equal to a wavelength-division-multiplexed (WDM) channel spacing, wherein optical sidebands in each pair comprise an upper sideband at an optical frequency higher than the laser frequency by a respective oscillation frequency of an electrical oscillation signal and a lower sideband at an optical frequency lower than the laser frequency by the respective oscillation frequency of an electrical oscillation signal;
optically filtering the modulated laser beam to suppress light at the laser frequency while transmitting the optical sidebands to produce an optical WDM beam carrying the pairs of optical sidebands;
splitting the optical WDM beam into separate optical WDM carrier beams along different optical paths, respectively;
optically modulating each separate optical WDM carrier beam to superimpose a baseband signal onto the respective optical WDM carrier beam to produce an optical WDM channel signal; and
combining the optical WDM channel signals into a WDM signal.

24. The method as in claim 23, wherein the modulation frequency is at an RF frequency.

25. The method as in claim 23, wherein the modulation frequency is at a microwave frequency.

26. The method as in claim 23, wherein the modulation frequency is at millimeter wave frequency.

27. A method for producing an optical signal, comprising:
optically modulating a continuous wave laser beam which is at a laser frequency at a modulation frequency to produce a modulated laser beam that carries a plurality of optical sidebands corresponding to different oscillation frequencies;
optically filtering the modulated laser beam to suppress light at the laser frequency while transmitting the optical sidebands to produce an optical WDM beam carrying the optical sidebands;
splitting the optical WDM beam into separate optical WDM carrier beams along different optical paths, respectively;
optically modulating each separate optical WDM carrier beam to superimpose a baseband signal onto the respective optical WDM carrier beam to produce an optical WDM channel signal; and
combining the optical WDM channel signals into a WDM signal.

28. The method as in claim 27, wherein:
the optical modulation to produce the modulated laser beam that carries the optical sidebands is an optical single sideband (OSSB) modulation.

29. The method as in claim 28, comprising:
applying a plurality of electrical modulation control signals at the different electrical oscillation frequencies to an optical Mach-Zehnder modulator which generates multiple optical carriers; and
controlling a signal phase in each of the electrical oscillation frequencies and consequently the phase of each associated optical carrier, to reduce the adjacent coherent crosstalk.

30. The method as in claim 27, wherein:
the optical modulation to produce the modulated laser beam that carries the optical sidebands is any optical double sideband (ODSB) modulation.

31. The method as in claim 30, comprising:
applying a plurality of electrical modulation control signals at the different electrical oscillation frequencies to an optical Mach-Zehnder modulator which generates multiple optical carriers; and
controlling a signal phase in each of the electrical oscillation frequencies and consequently the phase of each associated optical carrier to reduce the adjacent coherent crosstalk.

32. An optical signal generator, comprising:
a laser that produces a continuous wave laser beam at a laser frequency;
an optical modulator that receives the laser beam from the laser and modulates the laser beam in response to a plurality of electrical oscillation signals at different oscillation frequencies to produce a modulated laser beam that carries a plurality of optical sidebands corresponding to the oscillation frequencies at one side of the laser frequency while suppressing optical sidebands on the other side of the laser frequency and light at the laser frequency; and
a plurality of adjustable electrical phase control units in signal paths of the electrical oscillation signals, respectively, to control phase values of the electrical oscillation signals.

33. The optical signal generator as in claim 32, comprising:
a plurality of adjustable electrical power control units in signal paths of the electrical oscillation signals, respectively, to control power levels of the electrical oscillation signals.

34. The optical signal generator as in claim 32, comprising:
an optical splitter that receives the modulated laser beam and separates the optical sidebands in the modulated laser beam into separate optical carriers along different optical paths, respectively;
a plurality of optical baseband modulators respectively located in the optical paths, each optical baseband modulator operable to modulate a respective optical carrier to superimpose a baseband signal onto the respective optical carrier to produce an optical wavelength-division-multiplexed (WDM) channel signal; and
an optical combiner that combines the optical WDM channel signals from the optical baseband modulators into a WDM signal.

35. The optical signal generator as in claim 32, wherein:
the phase values of the electrical oscillation signals are controlled to render phases of two neighboring optical sidebands to be orthogonal to each other.
